(19) United States
(12) Patent Application Publication
(10) Pub. No.: US 2017/0211668 A1
(43) Pub. Date: Jul. 27, 2017

(54) ARMLIKE DRIVING MECHANISM

(71) Applicant: TSUNG-CHANG HSIEH, TAOYUAN CITY (TW)

(72) Inventor: TSUNG-CHANG HSIEH, TAOYUAN CITY (TW)

(21) Appl. No.: 15/007,451

(22) Filed: Jan. 27, 2016

(51) Int. Cl. F16H 19/06; B25J 9/10; F16H 37/12

(52) U.S. Cl. CPC F16H 19/0622; F16H 37/12; B25J 9/102; B25J 9/104; F16H 25/20

(57) ABSTRACT

An armlike driving mechanism includes a power source connected to a screw rod and a nut, a driving assembly including a first gear, a second gear, and a drive belt, a rail assembly including a linear rail and a sliding element, and a connecting block fixed on the drive belt and linked to the nut and the sliding element. The power source drives the screw rod and the nut by back and forth rotation, thereby displacing the sliding element in an X axle direction and driving the first gear in an Y axle direction by the connecting block and the drive belt, so as to operate the armlike driving mechanism.

### BACKGROUND OF THE INVENTION

1. Field of the Invention

The invention relates to an armlike driving mechanism, particularly to one that drives a drive belt and a first gear by a repeated back and forth rotation of a screw rod for operation.

2. Description of the Related Art

Nowadays manufacturing process in many industries require works with extreme precision, high risk, or high repeatability such as welding, casting, and automatic delivery. In most of these cases robotic arms are applied in replacement of human workers for purposes of better quality, safety, and better efficiency.

A structure of a robotic arm in the prior art is illustrated in FIG. 1. The robotic arm includes a first arm 12, a rotary shaft 15, a gearbox 14, a decelerator 13, a power supply device 17, and a body 18. The decelerator 13 is able to turn a high rotation speed of the power supply device 17 into a low rotation speed, and conveys the torque force to the rotary shaft 15 via the gearbox 14. The first arm 12 has a pivot 16 passing through the rotary shaft 15 to be operated by the rotation of the power supply device 17. Such structure has meshing gears for operation and deceleration, which brings defects like wear and tear of the gears and inaccuracies between the meshing gears; especially the later would further affect the precision of movements of the robotic arm. Also, the first arm 12 has quite a weight and consequently the impact created during the operation would cause damages to the power supply source 17. Therefore, further improvements are developed to overcome the defects disclosed.

### SUMMARY OF THE INVENTION

It is a primary object of the present invention to provide an armlike driving mechanism that can avoid wear and tear of gears resulted from meshing operations, and inaccuracies caused by the teeth of meshing gears.

Another object of the present invention is to provide an armlike driving mechanism that is able to protect a power source thereof from damages with braking force and impact resistance.

In order to achieve the objects above, the present invention comprises a housing having a space therein and a joint section made of a pair of installation holes arranged at a rear end thereof; a power source disposed at an upper section at a side in the space and engaged a screw rod; the screw rod having a nut screwing through with a same pitch as the screw rod; a driving assembly including a first gear, a second gear, and a drive belt; the first gear and second gear being respectively installed on a first pivot and a second pivot and the drive belt surrounding along the first and second gears for rolling; a rail assembly fixedly disposed at a lower section in the space, including a linear rail and a sliding element to displace along the linear rail; a connecting block fixed on the drive belt, having a top thereof fixedly linked to the nut and a bottom thereof fixedly linked to the sliding element; whereby the power source drives the screw rod to rotate back and forth to drive the nut, displacing the sliding element along an X axle and driving the drive belt to control a displacement along an Y axle of the first gear, so as to operate the armlike driving mechanism.

With structure disclose above, the first gear may have different rotating speed subject to a different pitch of the screw rod and the nut, and the first and second gears are able to perform a range of torque force with different number of teeth from one to the other. Furthermore, the second gear has a tensioner arranged aside to drive the second pivot for displacement in an X axle direction for tension adjusting of the drive belt. The drive belt is a timing belt and the first and second gears are timing belt pulleys; or the drive belt is a toothed belt and the first and second gears are sprockets.

As stated above, the present invention does not need a deceleration device and is not operated by meshing gear, avoiding the wear and tear and the inaccuracies that might occur during the operation. Besides, the present invention has the screw rod to drive the drive belt and the first gear for rotation, which is able to decelerate by itself; and the assembly has braking force and impact resistance to protect the power source from damages during operation.

### BRIEF DESCRIPTION OF THE DRAWINGS

FIG. 1 is a schematic diagram of a conventional robotic arm;

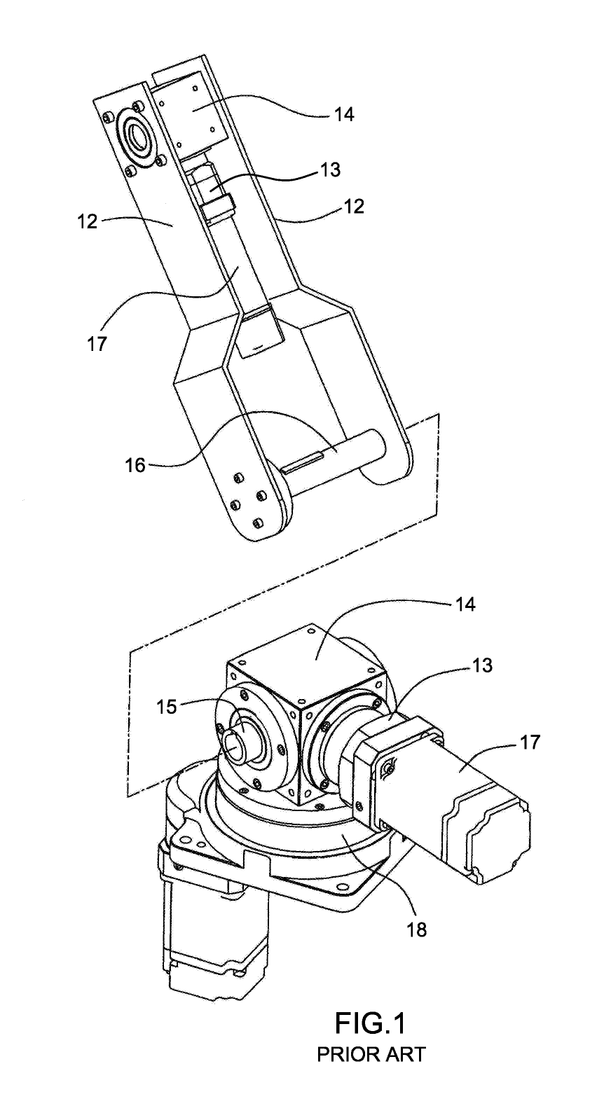

FIG. 2 is a perspective view of an assembly of the present invention in a preferred embodiment;

FIG. 3 is a sectional view of the present invention;

FIG. 4 is a schematic diagram of an operation of the present invention in the preferred embodiment; and

FIG. 5 is a practical application view of the present invention in the preferred embodiment.

### DETAILED DESCRIPTION OF THE PREFERRED EMBODIMENT

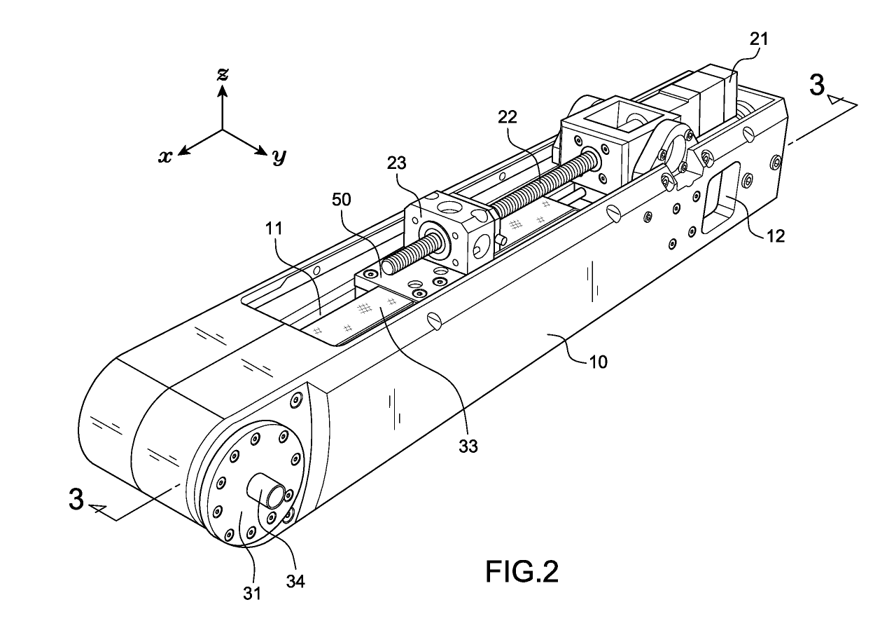

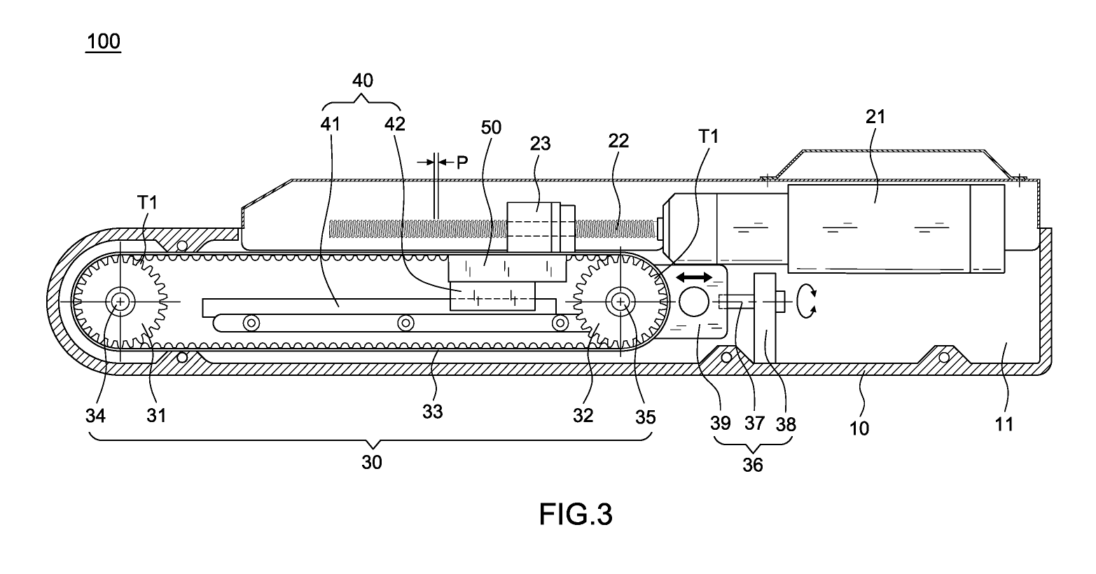

Referring to FIGS. 2 to 3, in an applicable embodiment, the present invention includes a housing 10, a power source 21, a driving assembly 30, a rail assembly 40, and a connecting block 50.

The housing 10 has a space 11 therein and a joint section 12 made of a pair of installation holes arranged at a rear end thereof for engagement. The power source 21 is disposed at an upper section at a side in the space 11 and engaged a screw rod 22. The screw rod 22 has a nut 23 screwing through with a same pitch P as the screw rod 22. In this embodiment, the power source is a servomotor and the screw rod 22 is a ball screw rod. The driving assembly 30 includes a first gear 31, a second gear 32, and a drive belt 33. The first gear 31 is installed on a first pivot 34 engaging the housing 10 and stretching out therefrom, and the second gear 32 is installed on a second pivot 35 engaging the housing 10 therein. The drive belt 33 is surrounding along the first and second gears 31, 32 for rolling.

The rail assembly 40 is fixedly disposed at a lower section in the space 11 and includes a linear rail 41 and a sliding element 42 to displace along the linear rail 41. The connecting block 50 is fixed on the drive belt 33 and has a top thereof fixedly linked to the nut 23 and a bottom thereof fixedly linked to the sliding element 42, so as to simultaneously displace the nut 23 and the sliding element 42 together with the drive belt 33.

whereby the power source 21 drives the screw rod 22 to rotate back and forth to drive the nut 23 along an X axle, simultaneously displacing the sliding element 42, the drive belt 33, and the connecting block 50, and further controlling a displacement of the first gear 31 in an Y axle direction, so as to operate the armlike driving mechanism with the first pivot 34 engaging the first gear 31.

In this embodiment, the first gear 31 has different rotating speed subject to a different pitch P of the screw rod 22 and the nut 23. With a power source 21 of the same rotation speed, a shorter pitch P results in shorter displacement distance of the drive belt 33 and therefore a slower rotation speed of the first gear 31; while a longer pitch P results in longer displacement distance of the drive belt 33 and therefore a faster rotation speed of the first gear 31. Moreover, the first gear 31 and the second gear 32 are able to perform a range of torque force with different number of teeth T1 from one to the other. With the same rotation speed of the first and second gears 31, 32 of, more teeth T1 would create greater torque; while less teeth T1 would create less torque.

In addition, the second gear 32 has a tensioner 36 including a fixing seat 38 linked to a movable block 39 by a screw 37. The head of the screw 37 is fixed to a movable block 39 linked to the second pivot 35, so that when the drive belt 33 requires maintenance, simply loosen the screw 37 to displace the movable block 39 toward the first gear 31 to release the tension of the drive belt 33; or when the tension needs to be enhanced, simply screw the screw 37 tighter and displace the movable block 39 further from the first gear 31 to enhance the tension of the drive belt 33. In this embodiment, the drive belt 33 is a timing belt and the first and second gears 31, 32 are timing belt pulleys; or the drive belt 33 can be a toothed belt and the first and second gears 31, 32 can be sprockets.

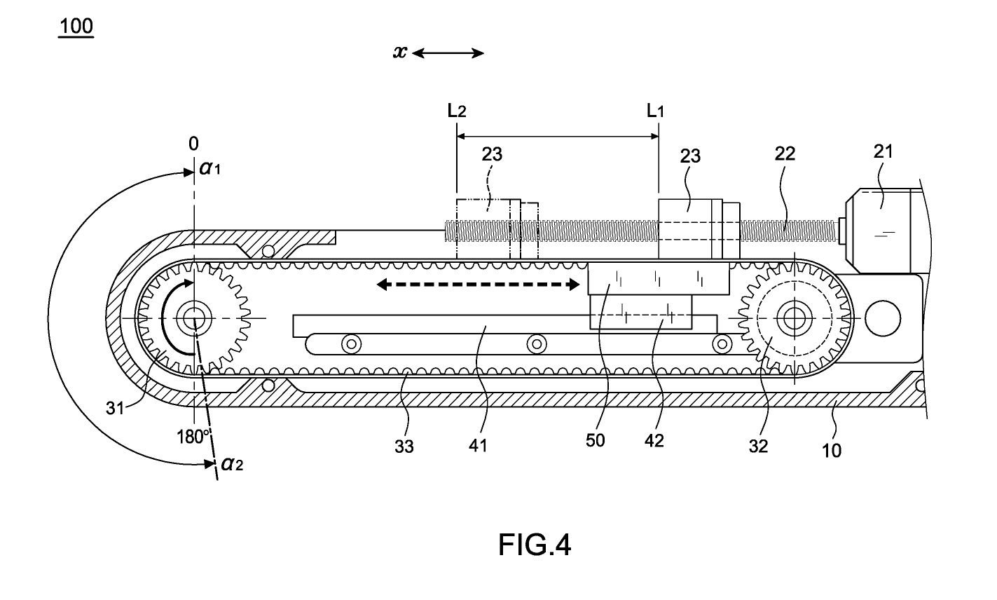

FIG. 4 illustrates the back and forth rotation of the first gear 31 in this embodiment. The power source 21 drives the screw rod 22 to rotate first and displaces the nut 23 and the linking drive belt 33 from a starting point L1 to an ending point L2. Since the drive belt 33 would drive the first gear 31 to rotate as well, the first gear 31 rotates from a starting point α1 to an ending point α2. While the power source 21 drives the screw rod 22 in an opposite direction later, the nut 23 and the linking drive belt 33 would displace from the ending point L2 back to the starting point L1, and the first gear 31 rotates from the ending point α2 back to the starting point α1. From the figure it also shows that the rotation angle of the first gear 31 would be over 180 °.

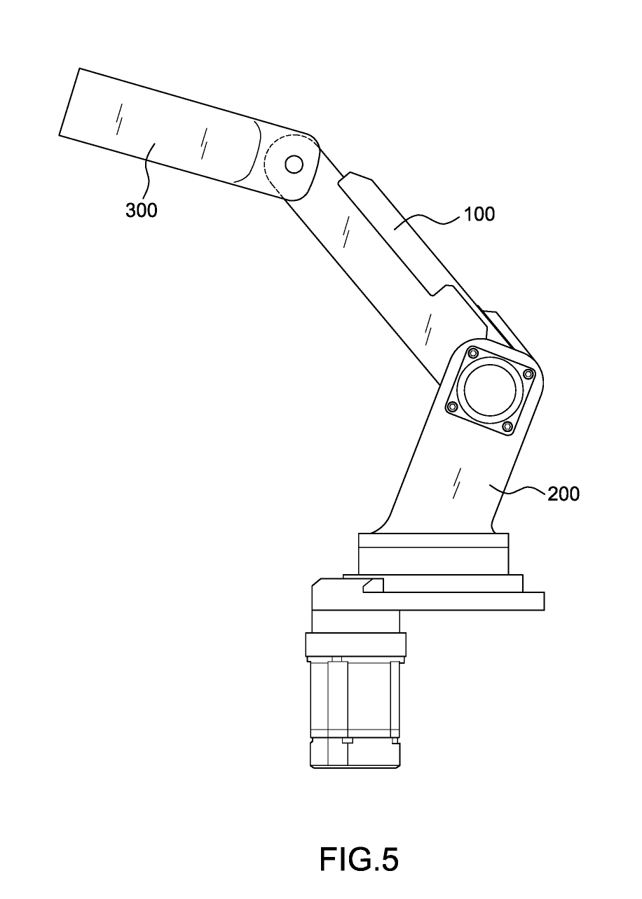

FIG. 5 shows the present invention, the armlike driving mechanism 100 applied to a robotic arm. The joint section 12 engages a support base 200 and a mechanic arm 300 engages the first pivot 34. In this embodiment the mechanic arm 300 is driven by the first gear 31 and the impact produced by the mechanic arm 300 during the operation is conveyed to the first gear 31, the drive belt 33, and the nut 23 due to a heavy weight of the mechanic arm 300. However, since the reverse displacement energy of the nut 23 cannot easily drive and rotate the screw rod 22, the screw rod 22 is therefore impact-resistant and is able to protect the power source 21 from damages resulted from the impacts.

In short, the present invention does not decelerates by a decelerator, and does not operate by meshing gears, avoiding the inaccuracies that happen in devices with meshing gears. Also, the design of the screw rod 22 driving the drive belt 33 and the first gear 31 achieves the deceleration function and has an impact-resistant feature with braking force similar to turbine decelerators, protecting the power source from damages.

What is claimed is:

1. An armlike driving mechanism, comprising:
a housing having a space therein and a joint section made of a pair of installation holes arranged at a rear end thereof;
a power source disposed at an upper section at a side in the space and engaged a screw rod, said screw rod having a nut screwing through with a same pitch as the screw rod;
a driving assembly including a first gear, a second gear, and a drive belt, said first gear and second gear being respectively installed on a first pivot and a second pivot and said drive belt surrounding along the first and second gears for rolling;
a rail assembly fixedly disposed at a lower section in the space, including a linear rail and a sliding element to displace along the linear rail;
a connecting block fixed on the drive belt, having a top thereof fixedly linked to the nut and a bottom thereof fixedly linked to the sliding element;
whereby the power source drives the screw rod to rotate back and forth to drive the nut, displacing the sliding element along an X axle and driving the drive belt to control a radial displacement of the first gear, so as to operate the armlike driving mechanism.

2. The armlike driving mechanism, as claimed in claim 1, wherein the first gear has different rotating speed subject to a different pitch of the screw rod and the nut.

3. The armlike driving mechanism, as claimed in claim 1, wherein the first gear and the second gear are able to perform a range of torque force with different number of teeth from one to the other.

4. The armlike driving mechanism, as claimed in claim 1, wherein the second gear has a tensioner arranged aside to drive the second pivot for displacement in an X axle direction for tension adjusting of the drive belt.

5. The armlike driving mechanism, as claimed in claim 4, wherein the drive belt is a timing belt and the first and second gears are timing belt pulleys.

6. The armlike driving mechanism, as claimed in claim 4, wherein the drive belt is a toothed belt and the first and second gears are sprockets.
